(19) United States
(12) Patent Application Publication
(10) Pub. No.: US 2015/0053837 A1
(43) Pub. Date: Feb. 26, 2015

(54) Decorative door handle and hinge

(71) Applicant: Charles D. Graham, Eureka, MO (US)

(72) Inventor: Charles D. Graham, Eureka, MO (US)

(21) Appl. No.: 14/121,164

(22) Filed: Aug. 7, 2014

Related U.S. Application Data
(60) Provisional application No. 61/959,303, filed on Aug. 20, 2013.

(51) Int. Cl. F16M 13/02

(52) U.S. Cl. CPC F16M 13/02
USPC 248/499

(57) ABSTRACT

A teething assembly for a spherically mounted retroreflector is disclosed in which the assembly comprises a wire having a central portion having a first end forming a first loop with the first end being secured to the central portion and a second end forming a second loop with the second end being secured to the central portion, a spring clip attached to the first loop, and a clip device attached to the second loop, the spring clip attaching onto the collar of a SMR.

### CROSS REFERENCE TO RELATED APPLICATION

This nonprovisional patent application claims priority to the provisional patent application having Ser. No. 61/959,303, filed on Aug. 20, 2013.

### FIELD OF THE DISCLOSURE

This disclosure generally relates to tethering assembly, and more particularly to a tethering assembly for securing a spherical retroreflector to a sphere mount.

### BACKGROUND

Modern manufacturing technology, particularly which associated with the construction of large composite material structures, requires the contours of components and tooling to be accurately measured and inspected for compliance with design models and specifications. One example of such a structure is a wing for a jet airplane. One manner in which these structures are measured is with the aid of portable coordinate measuring machines such as laser trackers. Laser trackers measure and inspect large components by illuminating one or more retroreflecting targets mounted to the components in predetermined locations with a laser. The distance between the laser tracker and the retroreflector target is measured using the laser, and compared with design models or specifications, such as those stored on a computer.

To facilitate the use of laser trackers, retroreflectors are centrally mounted in hollow steel balls, commonly referred to as Spherically Mounted Retroreflectors (SMR), which in turn are fitted to the target object in predetermined locations with the use of sphere mounts. The hollow steel balls include a circular opening or aperture in an exterior surface, through which laser light enters the ball and is reflected back along an incident angle to the source by the internally mounted retroreflector. Surrounding the circular opening or aperture is a cylindrical hood, configured to reduce or eliminate unwanted glare and to protect the glass optical retro-reflector from breakage. Each sphere mount is typically cylindrical or disc shaped and includes a recessed conical nest in one surface which holds and locates the retroreflector ball, usually with the aid of a magnet. The opposite surface of the sphere mount is either flat to within a predetermined tolerance or includes a base shank, configured for seating within a correspondingly sized bore on the target object, permitting the sphere mount to be located at a known position on the target object. For high tolerance applications, a sphere mount having a three-point conical nest, commonly referred to as a kinematic mount, may be utilized.

Conventional sphere mounts are available in a variety of standard sizes, such as 0.500″, 0.875″, and 1.500″. The mounts have a hemispherical range of illumination acceptance, which is generally limited by the mechanical interaction between the edge of the circular opening or aperture in the retroreflector ball and the upper surface of the sphere mount. The retroreflector ball in a conventional sphere mount may rotate through a vertical arc of 180 degrees and may rotate 360 degrees about the central axis within the conical nest of the sphere mount.

Once the retroreflector ball is placed in the sphere mount and on the component, the ball is subject to loss or damage unless the ball is secured to the sphere mount. The retroreflector balls are very expensive. Due to the various locations at which the retroreflector ball and the sphere mount are placed on a component, the ball may be knocked out of the mount and severely damaged when the ball impacts the ground. For example, a glass reflector inside the ball may break or the reflector may have its alignment changed. Additionally, the ball may be lost, especially if the component is being manufactured in a large area. In order to prevent loss of or damage to the sphere, various devices have been constructed to attach sphere to the sphere mount. Once attached if the sphere is knocked out of the mount, the sphere will only be left hanging from the mount and will not fall to the ground where it can be damaged or be lost. Also, the retroreflector balls are carried by individuals and may be accidentally dropped. In order to prevent dropping of the ball, adjustable wrist bands have been used to attach the retroreflector ball to the wrist band by use of an attaching device such as a lanyard or a tether. Although such attaching devices are useful, they are too large to be used with a half inch sphere mount. Further, there are no known attaching devices for use with a half inch sphere mount.

The present disclosure is designed to obviate and overcome many of the disadvantages and shortcomings experienced with prior attaching devices. Moreover, the present disclosure is related to a teething device for a spherically mounted retroreflector. The tethering device of the present disclosure is also simple to use and adjust when using a half inch sphere mount.

### SUMMARY OF THE DISCLOSURE

The present disclosure is directed to a teething assembly for a spherically mounted retroreflector in which the assembly comprises a wire having a central portion having a first end forming a first loop with the first end being secured to the central portion and a second end forming a second loop with the second end being secured to the central portion, a spring clip attached to the first loop, and a clip device attached to the second loop.

In light of the foregoing comments, it will be recognized that the present disclosure provides a tethering assembly for a spherically mounted retroreflector.

The present disclosure provides a tethering assembly for a spherically mounted retroreflector that can be easily employed with highly reliable results to secure a retroreflector ball to a sphere mount.

The present disclosure further provides a tethering assembly for a spherically mounted retroreflector that is universal in design and may be used with sphere mounts from different manufacturers.

The present disclosure provides a tethering assembly for a spherically mounted retroreflector that is easy to learn how to operate and does not require any advanced training.

The present disclosure provides a tethering assembly for a spherically mounted retroreflector that secures a retroreflector ball to a sphere mount to prevent damage to the retroreflector ball.

The present disclosure also provides a tethering assembly for a spherically mounted retroreflector that may be used with an adjustable wrist band instead of a sphere mount.

These and other advantages of the present disclosure will become apparent to those skilled in the art after considering the following detailed specification in conjunction with the accompanying drawings.

The present invention provides a tethering assembly preferably for use with the 0.5, or ½ inch, spherical mount retroreflector, to add to its protection during usage, conveyance, and storage.

### BRIEF DESCRIPTION OF THE DRAWINGS

In referring to the drawings:

FIG. 1 is a perspective view of a tethering assembly for a spherically mounted retroreflector constructed according to the present disclosure;

FIG. 2 is a front perspective view of a spring clip constructed according to the present disclosure;

FIG. 3 is a side view of the spring clip shown in FIG. 2;

FIG. 4 is a perspective view of a sphere mount with a tethering assembly connected to its frontal collar, through the use of a spring clip, which may be tethered to another structure, or even a wristband, to add safety and protection to the sphere mount during usage and conveyance; and

FIG. 5 is a front perspective view of a sphere mount, with the spring clip attached to its frontal collar.

### DETAILED DESCRIPTION OF PREFERRED EMBODIMENTS

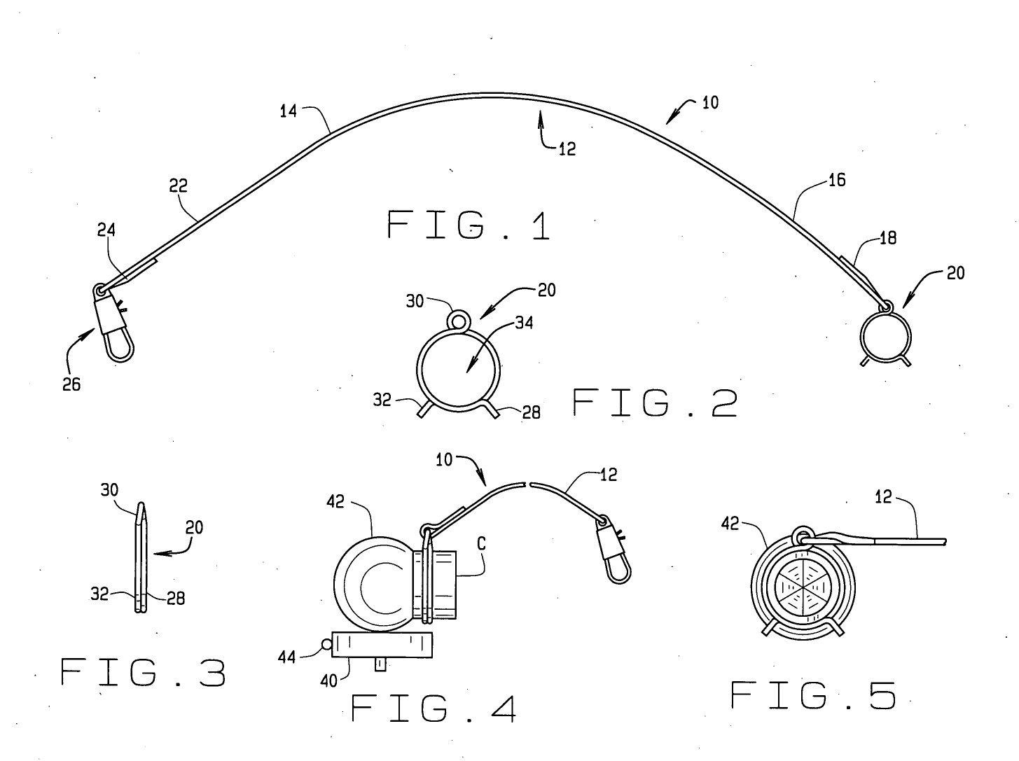

Referring now to the drawings, wherein like numbers refer to like items, number 10 identifies a preferred embodiment of a tethering assembly for a spherically mounted retroreflector constructed according to the present disclosure. With reference now to FIG. 1, the tethering assembly 10 comprises a wire rope or cable 12 having a central portion 14, a first end 16 which forms a first loop 18 with the first end 16 being tied or secured to the central portion 14, a spring clip 20 attached to the first loop 18. The tether also includes a second end 22 forming a second loop 24 being tied or secured to the central portion 14, and a locking clip device 26 attached to the second loop 24. The clip device 26 may be a miniaturized carabineer type device or a clasp type device. The spring clip 20 may be attached to a collar on the SMR, or other type connecting device (not shown) as on the half inch sphere mount (see FIG. 5). The clip device 26 may be attached to another fastener (not shown) on the mount on the one half inch spherically mounted retroreflector (not shown). Although, it is possible and contemplated to use clip 26 attached to a wristband of the user, especially during conveyance.

FIG. 2 shows a front perspective view of the spring clip 20 removed from the first loop 18. The spring clip 20 is fashioned from a single piece of stainless or related steel. The spring clip 20 has a first leg 28 that is curved up to a central loop portion 30 that is curved down to a second leg 32. The central loop portion 30 allows the end 16 to pass therethrough to secure the spring clip 20 to the wire 12. The legs 28 and 32 form a central opening 34. The central loop portion 30 secures the wire 12 therein and does not allow the wire 12 to fall into the central opening 34 where the spring clip 20 could be separated from the wire 12 or the first loop 18. The first leg 28 is in front of the second leg 32. In the manner, the legs 28 and 32 may be squeezed or pressed toward each other to separate the legs 28 and 32 to allow a spring clip to be connected onto the collar of the SMR, as known.

Referring now to FIG. 3, a side view of the spring clip 20 is illustrated. The spring clip 20 has the first leg 28 in front of the second leg 32. The legs 28 and 32 may be spread apart to allow another connecting device or spring clip therethrough to connect the spring clip 20 another supporting device. The central loop portion 30 is used to contain the loop 18 of the wire 12 therein. This prevents the spring clip 20 from being separated from the wire 12 or the loop 18.

FIG. 4 shows the tethering assembly 10 being secured to a collar C of a spherically mounted retroreflector 42. The sphere mount 40 may have a connecting device 44 attached to the mount 40 and the sphere mount retroreflector 42 attached to the tether 10, may connect to the device 44. The tethering assembly 10 is connected to the mount 40 by connecting the clip 26 to the connecting device 44 and is connected to the retroreflector 42 by connecting the spring clip 26. Or the clip 26 may connect to a wristband (not shown) or some other stable device, to protect the sphere mount 42 from falling or otherwise being damaged. In this manner, the retroreflector 42 will be tethered to the mount 40, or elsewhere, so that if the retroreflector 42 is knocked from the mount 40, the retroreflector 42 will not fall to the ground.

Although not shown, it is known that the retroreflector 42 may be tethered to an adjustable wrist band, as stated, so that an individual may safely carry the retroreflector 42. In order to secure the retroreflector 42 to a wrist band, the individual may connect the clip device 26 to an 0 ring or D ring associated with the wrist band, or even to the belt of the user. The clip device 26 is connected to any other stable device or mount, of the retroreflector 42.

From all that has been said, it will be clear that there has thus been shown and described herein a tethering device for containing a retroreflector. It will become apparent to those skilled in the art, however, that many changes, modifications, variations, and other uses and applications of the device for holding a sphere mount are possible and contemplated. For example, a cable, cord or the like, can be used in lieu of a wire rope for the device. All changes, modifications, variations, and other uses and applications which do not depart from the spirit and scope of the disclosure are deemed to be covered by the disclosure, which is limited only by the claims which follow.

What is claimed is:

1. A tethering assembly for connecting a spherically mounted retroreflector comprising:
a wire having a central portion having a first end forming a first loop with the first end being secured to the central portion and a second end forming a second loop with the second end being secured to the central portion;
a spring clip attached to the first loop; and
a clip device attached to the second loop.

2. The teething assembly for a spherically mounted retroreflector of claim 1 wherein the spring clip comprises a first leg curving up to a central loop portion and a second leg curving down from the central loop portion with the first leg and the second leg forming a central opening for securing upon the collar of a SMR.

3. The tethering assembly for a spherically mounted retroreflector of claim 2 wherein the central loop portion receives the first loop of the wire.

4. A tethering assembly for a spherically mounted retroreflector comprising:
a wire having a central portion having a first end forming a first loop with the first end being secured to the central portion and a second end forming a second loop with the second end being secured to the central portion;
a first spring clip attached to the first loop; and
a clip device attached to the second loop.
